(19) United States
(12) Patent Application Publication
(10) Pub. No.: US 2021/0323187 A1
(43) Pub. Date: Oct. 21, 2021

(54) PANEL CUTTING DEVICE AND PANEL CUTTING METHOD

(71) Applicant: SHENZHEN CHINA STAR OPTOELECTRONICS SEMICONDUCTOR DISPLAY TECHNOLOGY CO. LTD., Shenzhen, Guangdong (CN)

(72) Inventor: Deping GUO, Shenzhen, Guangdong (CN)

(21) Appl. No.: 16/492,407

(22) PCT Filed: Apr. 22, 2019
(86) PCT No.: PCT/CN2019/083668

§ 371 Date: Sep. 9, 2019

(30) Foreign Application Priority Data
Apr. 9, 2019 (CN) 201910278357.9

(51) Int. Cl. B26D 7/18; B26D 7/27; B26D 5/00

(52) U.S. Cl. CPC B26D 7/18; B26D 5/005; B26D 7/27

(57) ABSTRACT

The present invention provides a panel cutting device and a panel cutting method. By using a sensing member to sense a mass change of residual material and prompt according to the mass change of the residual, it can be determined according to a prompt whether to stop the panel cutting device from operating, so the residual material is prevented from entering downstream equipment and damaging display panels. This solves an existing problem in a conventional panel cutting device, which residual material enters downstream equipment and damages display panels.

### 1. FIELD OF DISCLOSURE

The present invention relates to a field of display devices and in particular, to a panel cutting device and a panel cutting method.

### 2. DESCRIPTION OF RELATED ART

In a conventional manufacturing process of a display panel, a motherboard of a display panel is cut into a normal-sized display panel in a cutting process, and in the cutting process, it is required to cut and remove residual material between the display panels.

Referring to FIGS. 1 and 2, often because of unideal cutting parameters, the residual material is not successfully pinched off, resulting in entry of the residual material into downstream equipment, which causes the display panel to be scratched by the residual material. Therefore, a conventional panel cutting device has a problem that the residual material enters the downstream equipment and damages the display panel, and the problem is in need of a solution.

The present invention provides a panel cutting device and a panel cutting method, which are used to provide a solution to a conventional panel cutting device by solving an existing problem that residual material enters downstream equipment to damage a display panel.

### SUMMARY

The present invention provides a panel cutting device and a panel cutting method, which are used to solve existing problems that a conventional panel cutting device causes residues to enter downstream equipment and damage a display panel.

Accordingly, the present invention provides solutions as follows.

The present invention provides a panel cutting device, the panel cutting device comprising:

a first machine table configured to support a first panel;

a cutting member configured to cut the first panel to obtain a second panel;

a second machine table connected to the first machine table through a first conveying belt;

a residue pinching member configured to pinch off residual material on the second panel and have the residual material dropped onto a second conveying belt; and

a sensing member configured to sense a mass change of the residual material and prompt according to the mass change of the residual material.

In the panel cutting device of the present invention, the sensing member comprises a first mass sensing assembly and a first feedback assembly, the first mass sensing assembly is configured to sense the mass change of the residual material and transmit a sensed data to the first feedback assembly, and the first feedback assembly is configured to prompt according to the sensed data.

In the panel cutting device of the present invention, the first mass sensing assembly is disposed on the second conveying belt at a position away from the residue pinching member, the first mass sensing assembly is not moved with the second conveying belt, and the first feedback assembly is configured to prompt when the sensed data is different from a first default data.

In the panel cutting device of the present invention, further comprising an input assembly, wherein the input assembly is configured to input the first default data according to a size of the second panel and transmit the first default data to the first feedback assembly.

In the panel cutting device of the present invention, further comprising a control assembly, wherein the control assembly is configured to stop the first conveying belt from moving when the first feedback assembly prompts.

In the panel cutting device of the present invention, further comprising an auxiliary cutting assembly, and the auxiliary cutting assembly being configured to cut the residual material which is not dropped off.

In the panel cutting device of the present invention, the sensing member comprises a second mass sensing assembly and a second feedback assembly, the second mass sensing assembly is configured to sense a mass change of the second panel and transmit a sensed data to the second feedback assembly, the second feedback assembly is configured to determine the mass change of the residual material according to the sensed data and prompt according to the mass change of the residual material.

In the panel cutting device of the present invention, the second mass sensing assembly is disposed on the first conveying belt at a position away from the residue pinching member, and the second mass sensing assembly is not moved with the first conveying belt.

In the panel cutting device of the present invention, the second mass sensing assembly is fixed inside the second machine table.

In the panel cutting device of the present invention, further comprising a distance measuring assembly and a third feedback assembly, wherein the distance measuring assembly is configured to measure a distance between the residual material and the distance measuring assembly and transmit the measured distance to the third feedback assembly, and the third feedback assembly prompts according to the measured distance.

In the panel cutting device of the present invention, the distance measuring assembly is disposed on the residue pinching member.

At the same time, the present invention provides a panel cutting method, the panel cutting method comprising:

providing a first machine table;

placing a first panel on the first machine table;

using a cutting member to cut the first panel to obtain a second panel;

using a residue pinching member to pinch off residual material on the second panel and have the residual material dropped onto a second conveying belt;

using a sensing member to sense a mass change of the residual material and prompt according to the mass change of the residual material; and

conveying through a first conveying belt the second panel to a second machine table.

In the panel cutting method of the present invention, the step of using the sensing member to sense the mass change of the residual material and prompt according to the mass change of the residual material comprises: using a first mass sensing assembly to sense the mass change of the residual material and transmit a sensed data to a first feedback assembly, using the first feedback assembly to prompt according to the sensed data, wherein the sensing member comprises the first mass sensing assembly and the first feedback assembly.

In the panel cutting method of the present invention, the step of using the first mass sensing assembly to sense the mass change of the residual material comprises: placing the first mass sensing assembly on the second conveying belt at a position away from the residue pinching member.

In the panel cutting method of the present invention, the step of using the first feedback assembly to prompt according to the sensed data comprises: using the first feedback assembly to prompt when the sensed data is different from a first default data.

In the panel cutting method of the present invention, further comprising: using an input assembly to transmit the first default data to the first feedback assembly.

In the panel cutting method of the present invention, further comprising: using a control assembly to stop the first conveying belt from moving when the first feedback assembly prompts.

In the panel cutting method of the present invention, further comprising: using an auxiliary cutting assembly to cut the residual material which is not dropped off when the first feedback assembly prompts.

In the panel cutting method of the present invention, further comprising: using a distance measuring assembly to measure a distance between the residual material and the distance measuring assembly and transmit the measured distance to a third feedback assembly, and using the third feedback assembly to prompt according to the measured distance.

In the panel cutting method of the present invention, the step of using the distance measuring assembly to measure the distance between the residual material and the distance measuring assembly comprises: placing the distance measuring assembly on the residue pinching member.

### Advantages

The present invention provides a panel cutting device. The panel cutting device comprises a first machine table, a cutting member, a second machine table, a residue pinching member, and a sensing member. The first machine table is configured to support a first panel. The cutting member is configured to cut the first panel to obtain a second panel. The second machine table is connected to the first machine table through a first conveying belt. The residue pinching member is configured to pinch off residual material on the second panel and have the residual material dropped onto a second conveying belt. The sensing member is configured to sense a mass change of the residual material and prompt according to the mass change of the residual material. By using the sensing member to sense the mass change of the residual material and prompt according to the mass change of the residual material, it can be determined according to a prompt whether to stop the panel cutting device from operating. This configuration prevents the residual material from entering downstream equipment and damaging the display panel, and provides a solution to a conventional panel cutting device by solving an existing problem that residual material enters downstream equipment and damages the display panel.

### BRIEF DESCRIPTION OF DRAWINGS

In order to more clearly illustrate the embodiments of the present disclosure or related art, figures which will be described in the embodiments are briefly introduced hereinafter. It is obvious that the drawings are merely for the purposes of illustrating some embodiments of the present disclosure, and a person having ordinary skill in this field can obtain other figures according to these figures without an inventive work or paying the premise.

FIG. 1 is a schematic view of a prior art illustrating that a conventional residue pinching member pinches off residual material;

FIG. 2 is a schematic view of a prior art showing that residual material damages a display panel;

FIG. 3 is a first schematic view illustrating a panel cutting device according to one embodiment of the present invention;

FIG. 4 is a second schematic view illustrating the panel cutting device according to one embodiment of the present invention;

FIG. 5 is a third schematic view illustrating the panel cutting device according to one embodiment of the present invention;

FIG. 6 is a fourth schematic view illustrating the panel cutting device according to one embodiment of the present invention;

FIG. 7 is a fifth schematic view illustrating the panel cutting device according to one embodiment of the present invention; and

FIG. 8 is a schematic view illustrating a panel cutting method according to one embodiment of the present invention.

### DETAILED DESCRIPTION OF EMBODIMENTS

Embodiments of the present disclosure are described in detail with reference to the accompanying drawings as follows. Directional terms such as up/down, front/rear, right/left, inside/outside, and the like may be used for the purpose of enhancing a reader's understanding about the accompanying drawings, but are not intended to be limiting. Specifically, the terminologies in the embodiments of the present disclosure are merely for the purpose of describing certain embodiments, but not intended to limit the scope of the invention. The same reference numbers are used throughout the drawings to refer to the same or similar parts.

The present invention aims to provide a solution to a conventional panel cutting device by solving an existing problem that residual material enters downstream equipment and damages a display panel.

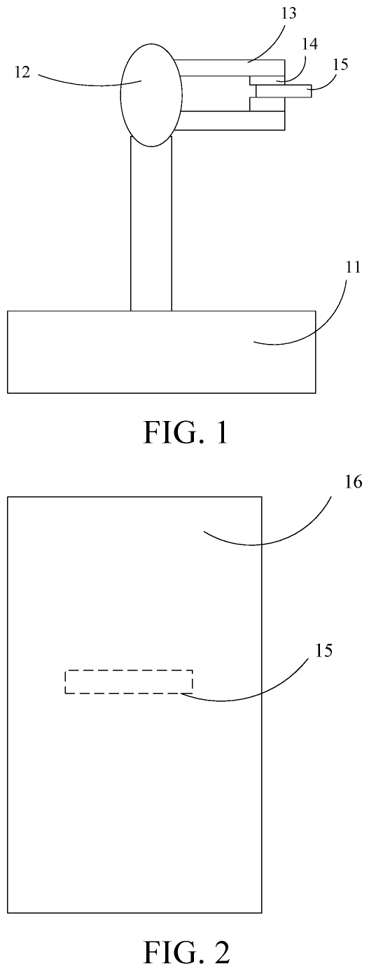

Referring to FIG. 1, a conventional cutting device comprises a residue pinching member, the residue pinching member includes a base 11, a rotation shaft 12, and a residue clamp 13 disposed on the rotation shaft 12 and configured in a symmetrical manner about the rotation shaft 12. A cushion 14 is disposed on the residue clamp 13. When residual material 15 is clamped by the residue pinching member, the residue clamp 13 is rotated, so that the symmetrically configured residue clamp 13 clamps and pinches off the residual material 15. However, in practice, there are often problems, such as the failing to clamp the residual material or pinch off the residual material, resulting in that the residual material enters downstream equipment. As shown in FIG. 2, the residual material 15 falls under the display panel 16, which causes a large area of a display panel 16 to be scratched. Thus, a conventional panel cutting device has a technical problem that residual material enters downstream equipment to damage a display panel.

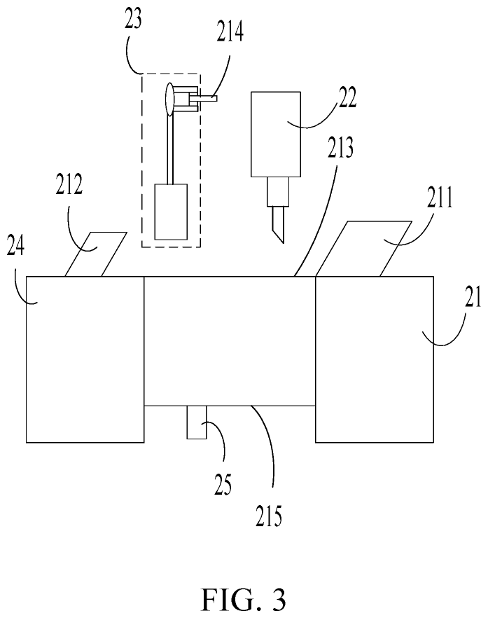

Referring to FIGS. 3 to 7, the present invention provides a panel cutting device, the panel cutting device comprising:

a first machine table 21 configured to support a first panel 211;

a cutting member 22 figured to cut the first panel 211 to obtain a second panel 212;

a second machine table 24 connected to the first machine table 21 through a first conveying belt 213;

a residue pinching member 23 configured to pinch off residual material 214 on the second panel 212 and have the residual material 214 dropped onto a second conveying belt 215; and

a sensing member 25 configured to sense a mass change of the residual material 214 and prompt according to the mass change of the residual material 214.

A panel cutting device is provided according to one embodiment of the present invention. The panel cutting device comprises a first machine table, a cutting member, a second machine table, a residue pinching member, and a sensing member. The first machine table is configured to support a first panel. The cutting member is figured to cut the first panel to obtain a second panel. The second machine table is connected to the first machine table through a first conveying belt. The residue pinching member is configured to pinch off residual material on the second panel and have the residual material dropped onto a second conveying belt. The sensing member is configured to sense a mass change of the residual material and prompt according to the mass change of the residual material. Therefore, it is possible to determine according to prompts whether to stop the panel cutting device from operating, thus preventing the residual material from damaging the display panel, and providing a solution to a conventional panel cutting device by solving an existing problem that residual material enters downstream equipment and damages display panels.

It should be noted that, in the drawings, the first conveying belt and the second conveying belt are not on a same vertical plane. Planes in which components of the panel cutting device are located do not indicate their actual positions. The first panel is placed in parallel with the first machine table, and the second panel is placed in parallel with the second machine table.

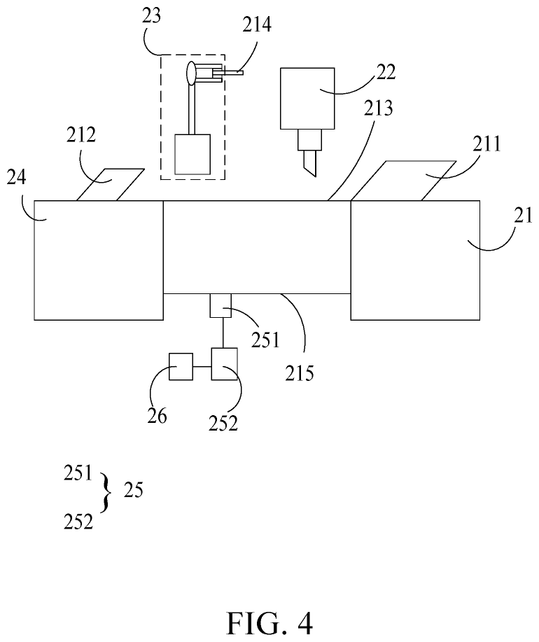

Referring to FIG. 4, according to one embodiment of the present invention, the sensing member 25 comprises a first mass sensing assembly 251 and a first feedback assembly 252, the first mass sensing assembly 251 is configured to sense the mass change of the residual material. The sensing member 25 comprises the first mass sensing assembly 251. According to the mass change of the residual material, for example: the mass change of the residual material is different from a default mass change, it is determined that the residual material is not dropped off from the second panel. Then, a sensed data is transmitted to the first feedback assembly, and the first feedback assembly prompts according to the sensed data. If the sensed mass change is the same as the default mass change, it means that the residual material is dropped off, and the sensed data can also be transmitted to the first feedback assembly, so that the first feedback assembly can prompt according to the sensed data.

According to one embodiment of the present invention, the first feedback assembly prompts differently according to the actual sensed data. For example, in a case where an indicator light is used to prompt, when the actual sensed mass change is the same as the default mass change, a green indicator light is on to indicate a normal operation state, so that the panel cutting device continues to operate. When the actual sensed mass change is different from the default mass change, a red indicator light is on to indicate an abnormal operation state, so that a person can adjust or repair to prevent the residual material from damaging the display panel. In a case where a prompt is provided by making a sound, when the actual sensed mass change is the same as the default mass change in an example, no sound is made or a specific sound is emitted to indicate the normal operation state; when the actual sensed mass change and the default mass change are different, an alarm sound or a specific sound is emitted to indicate the abnormal state, so that the personnel can adjust or repair, thereby preventing the residual material from damaging the display panel.

It should be noted that the default mass change is determined by a mass of the residual material corresponding to a size of the display panel, and then the mass change of the residual material can be calculated. The specific sound can be selected according to actual situations, and the present invention is not limited in this regard.

According to one embodiment of the present invention, the first mass sensing assembly is disposed on the second conveying belt at a position away from the residue pinching member, and the first mass sensing assembly is not moved with the second conveying belt. The first mass sensing assembly is disposed under the second conveying belt (e.g., the first mass sensing assembly is disposed at a position of the sensing member in FIG. 3). According to a sensed result of the first mass sensing assembly, the first feedback assembly determines whether the residual material is dropped off or dropped entirely, and prompts when the sensed result is different from a first default data, so that the personnel can adjust or repair to prevent the residual material from entering downstream equipment and damaging the display panel.

It should be noted that, the first default data is the default mass change of the residual material, which is preset according to different sizes of panels in actual processes. For example, when the residual material is not dropped off or partially dropped, the sensed mass change is different from the first default data, so that it can be determined whether the residual material is not dropped off or only partially dropped, and a subsequent procedure can be taken to prevent the display panel from being scratched by the residual material.

It should be noted that the first panel refers to an uncut mother panel or a panel that is obtained by cut one or several times, and the second panel refers to a cut out panel or a display panel finally obtained.

Referring to FIG. 4, according to one embodiment of the present invention, the panel cutting device further comprises an input assembly 26. The input assembly is configured to input a first default data according to a size of the second panel. In practice, the mass of the residual material is determined according to the size of the second panel, thereby the mass change of the residual material can be determined, then the mass change of the residual material is set as the first default data, and the first default data is transmitted to the first feedback assembly, so that the first feedback assembly compares the sensed data with the first default data, and prompts according to a comparison result, thus solving the existing problem of the conventional panel cutting device that the residual material enters the downstream equipment and damages the display panel.

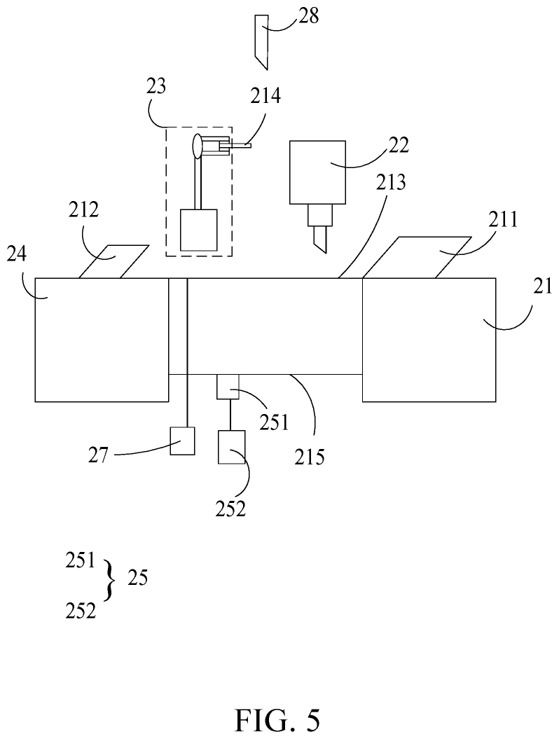

Referring to FIG. 5, according to one embodiment of the present invention, the sensing member 25 comprises a first mass sensing assembly 251 and a first feedback assembly 252. The first feedback assembly 252 prompts when the sensed data is different from the first default data. The panel cutting device further comprises a control assembly 27 and an auxiliary cutting assembly 28. The control assembly 27 is used to stop the first conveying belt 213 from moving when the first feedback assembly 252 prompts. The auxiliary cutting assembly 28 is configured to cut the remaining residual material when the residual material is not dropped off or partially dropped.

According to the present embodiment, the first feedback assembly prompts that there is a subsequent need to prevent the residual material from damaging the display panel. Accordingly, a control assembly can be added, so that when the first feedback assembly prompts that the residual material is not dropped or partially dropped, the control assembly can stop the first conveying belt to prevent the residual material from entering the downstream equipment, or the control assembly can stop the panel cutting device from operating and prevent the residual material from damaging the display panel.

According to the present embodiment, the panel cutting device has an auxiliary cutting assembly. Therefore, when the residual material is not cut off and dropped or just partially dropped, the first conveying belt can be stopped, and then the auxiliary cutting assembly is used to cut off the residual material to allow the panel cutting device to continue to operate normally. The auxiliary cutting assembly can be operated manually or according to instructions as required.

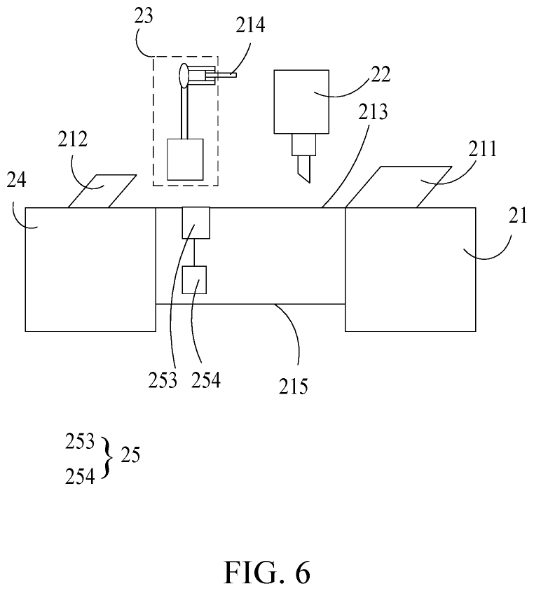

Referring to FIG. 6, according to one embodiment of the present invention, the sensing member 25 comprises a second mass sensing assembly 253 and a second feedback assembly 254. The second mass sensing assembly 253 is configured to sense a mass change of the second panel 212 and transmit a sensed data to the second feedback assembly 254, the second mass sensing assembly 253 is configured to measure the mass change of the second panel 212 and transmit the sensed data to the second feedback assembly 254. The second feedback assembly 254 determines the mass change of the residual material according to the sensed data and prompts according to the mass change of the residual material.

According to the present embodiment, the second mass sensing assembly senses the mass change of the second panel, the second feedback assembly determines the mass change of the residual material according to the mass change of the second panel. Therefore, the mass change of the residual material can be compared with a default value, and a prompt can be provided according to a comparison result. For example, in the case where the residual material is not dropped off or partially dropped, the second mass sensing assembly senses the mass change of the second panel and transmits the mass change of the second panel to the second feedback assembly. Then, the second feedback assembly determines the mass change of the residual material according to the mass change of the second panel. By comparison, it can be determined whether the mass change of the residual material is different from the first default data, so a prompt is provided to indicate that the residual material is not yet dropped or is dropped entirely.

Referring to FIG. 6, according to one embodiment of the present invention, the second mass sensing assembly 253 is disposed under the first conveying belt 213, and the second mass sensing assembly 253 is not moved with the first conveying belt 213. In the present embodiment, the second mass sensing assembly is disposed under the first conveying belt, so that the second mass sensing assembly can sense the mass change of the second panel, and the mass change of the residual material is thereby determined, thus preventing the residual material from entering the downstream equipment and damaging the display panel.

In the present embodiment, the second feedback assembly can prompt by using an indicator light or a sound, etc. The indicator light or the sound is arranged according to actual needs.

In the present embodiment, an input assembly can be added for inputting the first default data and transmitting the first default data to the first feedback assembly, and the control assembly can also be added. The control assembly is configured to control the first conveying belt, so as to stop the first conveying belt from moving when the residual material is not dropped or partially dropped. In addition, the auxiliary cutting assembly can be added to cut off the remaining residual material when the residual material is not dropped or partially dropped.

In one embodiment, for panels of different sizes, the input assembly can determine the first default data according to different sizes of the panels during actual operation processes, so that the panel cutting device can prevent the residual material from damaging the display panels of different sizes.

According to one embodiment of the present invention, the second mass sensing assembly is disposed on the second machine table. The second mass sensing assembly is disposed on the second machine table to sense the mass change of the second panel and transmit the mass change of the second panel to the second feedback assembly. The second feedback assembly determines the mass change of the residual material according to the mass change of the second panel and prompts according to the mass change of the residual material, thereby preventing the residual material from scratching and damaging the display panel.

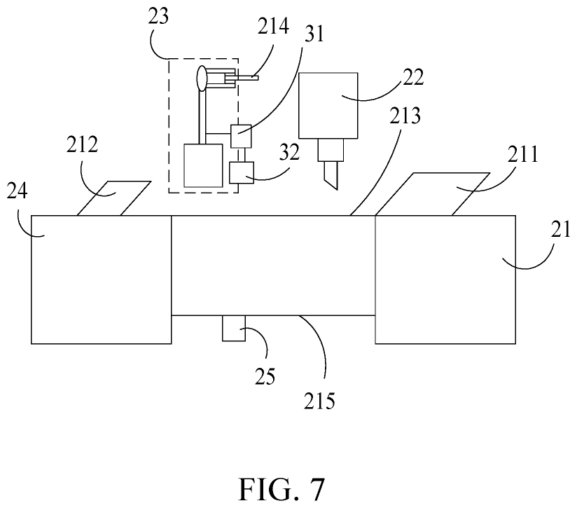

Referring to FIG. 7, according to one embodiment of the present invention, the panel cutting device further comprises a distance measuring assembly 31 and a third feedback assembly 32, wherein the distance measuring assembly 31 is configured to measure a distance between the residual material 214 and the distance measuring assembly 31 and transmit the measured distance to the third feedback assembly 32, and the third feedback assembly 32 prompts according to the measured distance. By having the distance measuring assembly which can measure the distance between the residual material and the distance measuring assembly, the panel cutting device can determine whether the residual material is dropped. In the case where the residual material is not dropped, then the distance measuring assembly senses that the distance is different from the second default data, so it can be determined that the residual material is not dropped, and the third feedback assembly prompts to prevent the residual material from scratching and damaging the display panel.

It should be noted that, the second default data is the distance between the residual material and the distance measuring assembly after the residual material drops, wherein the distance is determined based on an actual measurement.

Referring to FIG. 7, according to one embodiment of the present invention, the distance measuring assembly 31 is disposed on the residue pinching member 23. By using the distance measuring assembly to measure the distance between the residual material and the distance measuring assembly, it can be determined whether the residual material is dropped, and the third feedback assembly is used to prompt to prevent the residual material from damaging the display panel.

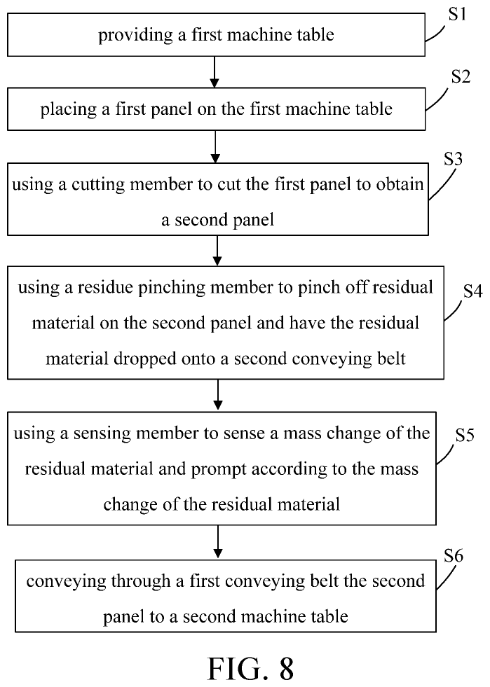

Referring to FIG. 8, the present invention provides a panel cutting method, the panel cutting method comprises:

S1: providing a first machine table;

S2: placing a first panel on the first machine table;

S3: using a cutting member to cut the first panel to obtain a second panel;

S4: using a residue pinching member to pinch off residual material on the second panel and have the residual material dropped onto the second conveying belt;

S5: using a sensing member to sense a mass change of the residual material and prompt according to the mass change of the residual material; and

S6: conveying through the first conveying belt the second panel to the second machine table.

The present embodiment provides a panel cutting method. The panel cutting method uses the above-mentioned panel cutting device. The panel cutting device comprises the first machine table, the cutting member, the second machine table, the residue pinching member, and the sensing member. The first machine table is configured to support the first panel. The cutting member is configured to cut the first panel to obtain the second panel. The second machine table is connected to the first machine table through the first conveying belt. The residue pinching member is configured to pinch off the residual material on the second panel and have the residual material dropped onto the second conveying belt. The sensing member is configured to sense the mass change of the residual material and prompt according to the mass change of the residual material. The panel cutting device has the sensing member which senses the mass change of the residual material and prompts according to the mass change of the residual material, so whether to stop the panel cutting device from operating can be determined according to a prompt, thus preventing the residual material from entering the downstream equipment and damaging the display panel, and solving the existing problems of the conventional panel cutting devices, which the residual material enters the downstream equipment and damages the display panels.

In the present embodiment, the cutting member cuts the first panel to obtain the second panel, but the residual material is on the second panel, and the residue pinching member may fail to pinch off the residual material. In the present embodiment, the sensing member senses the mass change of the residual material, and prompts according to the mass change of the residual material to prevent the residual material from entering the downstream equipment and damaging the display panel.

According to one embodiment of the present invention, the panel cutting device comprises the first mass sensing assembly and the first feedback assembly. The first mass sensing assembly is used to sense the mass change of the residual material, and then transmit the sensed data to the first feedback assembly. The first feedback assembly prompts when the sensed data is different from the first default data, so as to prevent the residual material from damaging the display panel.

According to one embodiment of the present invention, the panel cutting device comprises the second mass sensing assembly and the second feedback assembly. The second mass sensing assembly is used to sense the mass change of the second panel, and transmit the sensed data to the second feedback assembly. The second feedback assembly determines the mass change of the residual material according to the mass change of the second panel, and the second feedback assembly prompts when the mass change of the residual material is different from the first default data, so as to prevent the residual material from damaging the display panel.

According to one embodiment of the present invention, the panel cutting method further comprises using the distance measuring assembly to measure the distance between the residual material and the distance measuring assembly and transmit the measured distance to the third feedback assembly. The third feedback assembly prompts when the measured distance is different from the second default data, so as to prevent the residual material from scratching and damaging the display panel.

According to the above embodiments, it can be known that, the present invention provides a panel cutting device and a panel cutting method. The panel cutting device comprises a first machine table, a cutting member, a second machine table, a residue pinching member, and a sensing member. The first machine table is configured to support a first panel. The cutting member is configured to cut the first panel to obtain a second panel. The second machine table is connected to the first machine table through a first conveying belt. The residue pinching member is configured to pinch off residual material on the second panel and have the residual material dropped onto a second conveying belt. The sensing member is configured to sense a mass change of the residual material and prompt according to the mass change of the residual material. By using the sensing member to sense the mass change of the residual material, it can be determined whether to stop the panel cutting device from operating, thus preventing the residual material from entering the downstream equipment and damaging the display panel, hence solving an existing problem of conventional panel cutting devices, which residual material enters downstream equipment and damages a display panel.

It is to be understood that the above descriptions are merely the preferable embodiments of the present invention and are not intended to limit the scope of the present invention. Equivalent changes and modifications made in the spirit of the present invention are regarded as falling within the scope of the present invention.

What is claimed is:

1. A panel cutting device, comprising:
a first machine table configured to support a first panel;
a cutting member configured to cut the first panel to obtain a second panel;
a second machine table connected to the first machine table through a first conveying belt;
a residue pinching member configured to pinch off residual material on the second panel and have the residual material dropped onto a second conveying belt; and
a sensing member configured to sense a mass change of the residual material and prompt according to the mass change of the residual material.

2. The panel cutting device according to claim 1, wherein the sensing member comprises a first mass sensing assembly and a first feedback assembly, the first mass sensing assembly configured to sense the mass change of the residual material and transmit a sensed data to the first feedback assembly, and the first feedback assembly configured to prompt according to the sensed data.

3. The panel cutting device according to claim 2, wherein the first mass sensing assembly is disposed on the second conveying belt at a position away from the residue pinching member, the first mass sensing assembly is not moved with the second conveying belt, and the first feedback assembly is configured to prompt when the sensed data is different from a first default data.

4. The panel cutting device according to claim 3, further comprising an input assembly, wherein the input assembly is configured to input the first default data according to a size of the second panel and transmit the first default data to the first feedback assembly.

5. The panel cutting device according to claim 3, further comprising a control assembly, wherein the control assembly is configured to stop the first conveying belt from moving when the first feedback assembly prompts.

6. The panel cutting device according to claim 3, further comprising an auxiliary cutting assembly, and the auxiliary cutting assembly configured to cut residual material which is not dropped off.

7. The panel cutting device according to claim 1, wherein the sensing member comprises a second mass sensing assembly and a second feedback assembly, the second mass sensing assembly is configured to sense a mass change of the second panel and transmit a sensed data to the second feedback assembly, the second feedback assembly is configured to determine the mass change of the residual material according to the sensed data and prompt according to the mass change of the residual material.

8. The panel cutting device according to claim 7, wherein the second mass sensing assembly is disposed on the first conveying belt at a position away from the residue pinching member, and the second mass sensing assembly is not moved with the first conveying belt.

9. The panel cutting device according to claim 7, wherein the second mass sensing assembly is fixed inside the second machine table.

10. The panel cutting device according to claim 1, further comprising a distance measuring assembly and a third feedback assembly, wherein the distance measuring assembly is configured to measure a distance between the residual material and the distance measuring assembly and transmit the measured distance to the third feedback assembly, and the third feedback assembly prompts according to the measured distance.

11. The panel cutting device according to claim 10, wherein the distance measuring assembly is disposed on the residue pinching member.

12. A panel cutting method, comprising:
providing a first machine table;
placing a first panel on the first machine table;
using a cutting member to cut the first panel to obtain a second panel;
using a residue pinching member to pinch off residual material on the second panel and have the residual material dropped onto a second conveying belt;
using a sensing member to sense a mass change of the residual material and prompt according to the mass change of the residual material; and
conveying through a first conveying belt the second panel to a second machine table.

13. The panel cutting method according to claim 12, wherein the step of using the sensing member to sense the change regarding the mass of the residual material and prompt according to the mass change of the residual material comprises: using a first mass sensing assembly to sense the mass change of the residual material and transmit a sensed data to a first feedback assembly, using the first feedback assembly to prompt according to the sensed data, wherein the sensing member comprises the first mass sensing assembly and the first feedback assembly.

14. The panel cutting method according to claim 13, wherein the step of using the first mass sensing assembly to sense the mass change of the residual material comprises: placing the first mass sensing assembly on the second conveying belt at a position away from the residue pinching member.

15. The panel cutting method according to claim 14, wherein the step of using the first feedback assembly to prompt according to the sensed data comprises: using the first feedback assembly to prompt when the sensed data is different from a first default data.

16. The panel cutting method according to claim 15, further comprising: using an input assembly to transmit the first default data to the first feedback assembly.

17. The panel cutting method according to claim 15, further comprising: using a control assembly to stop the first conveying belt from moving when the first feedback assembly prompts.

18. The panel cutting method according to claim 15, further comprising: using an auxiliary cutting assembly to cut the residual material which is not dropped off when the first feedback assembly prompts.

19. The panel cutting method according to claim 12, further comprising: using a distance measuring assembly to measure a distance between the residual material and the distance measuring assembly and transmit the measured distance to a third feedback assembly, and using the third feedback assembly to prompt according to the measured distance.

20. The panel cutting method according to claim 12, the step of using the distance measuring assembly to measure the distance between the residual material and the distance measuring assembly comprises: placing the distance measuring assembly on the residue pinching member.
